(19) United States
(12) Patent Application Publication
(10) Pub. No.: US 2023/0387709 A1
(43) Pub. Date: Nov. 30, 2023

(54) POWER SUPPLY CONTROL DEVICE, METHOD, AND NON-TRANSITORY STORAGE MEDIUM

(71) Applicant: TOYOTA JIDOSHA KABUSHIKI KAISHA, Toyota-shi (JP)

(72) Inventor: Fumiyasu MIYOSHI, Anjo-shi (JP)

(73) Assignee: TOYOTA JIDOSHA KABUSHIKI KAISHA, Toyota-shi (JP)

(21) Appl. No.: 18/308,168

(22) Filed: Apr. 27, 2023

(30) Foreign Application Priority Data
May 25, 2022 (JP) 2022-085222

(51) Int. Cl. H02J 7/00; B60R 16/033

(52) U.S. Cl. CPC H02J 7/007182; B60R 16/033; H02J 7/0048

(57) ABSTRACT

A power supply control device configured to control power supply from a battery to a load in a vehicle, the power supply control device includes one or more processors configured to: acquire information of the vehicle; acquire a charge amount of the battery; identify a usage state of the vehicle corresponding to the acquired information of the vehicle; and restrict the power supply from the battery to the load based on the identified usage state of the vehicle, when the acquired charge amount of the battery is less than a first threshold.

### CROSS-REFERENCE TO RELATED APPLICATION

This application claims priority to Japanese Patent Application No. 2022-085222 filed on May 25, 2022, incorporated herein by reference in its entirety.

### BACKGROUND

### 1. Technical Field

The present disclosure relates to a power supply control device, a method, and a non-transitory storage medium.

### 2. Description of Related Art

Japanese Unexamined Patent Application Publication No. 2011-172318 (JP 2011-172318 A) discloses a power supply system capable of extending battery life while securing the minimum amount of power required for vehicle operation. It is described that this power supply system restricts driving of in-vehicle equipment in descending order of priority according to the amount of power that can be output by the battery.

### SUMMARY

Vehicles are used in various ways and placed in various situations. For this reason, there is a possibility that appropriate function restriction according to the usage state of the vehicle cannot be achieved by only controlling the drive of in-vehicle equipment (load) based on the electric power amount (charge amount) of the battery. Thus, there is room for further improvement with respect to the method of restricting the function of the load based on the charge amount in the battery.

The present disclosure provides a power supply control device, a method, and a non-transitory storage medium capable of appropriately restricting a function of a load such as in-vehicle equipment according to a usage state of a vehicle.

A power supply control device according to a first aspect of the present disclosure controls power supply from a battery to a load in a vehicle. The power supply control device includes one or more processors configured to: acquire information of the vehicle; acquire a charge amount of the battery; identify a usage state of the vehicle corresponding to the acquired information of the vehicle; and restrict the power supply from the battery to the load based on the identified usage state of the vehicle, when the acquired charge amount of the battery is less than a first threshold.

A method according to a second aspect of the present disclosure is a method executed by a computer of a power supply control device that controls power supply from a battery to a load in a vehicle. The method includes: acquiring information of the vehicle; acquiring a charge amount of the battery; identifying a usage state of the vehicle corresponding to the information of the vehicle; and restricting the power supply from the battery to the load based on the usage state of the vehicle, when the charge amount of the battery is less than a first threshold.

A non-transitory storage medium according to a third aspect of the present disclosure is a non-transitory storage medium storing instructions that are executable by one or more processors of a power supply control device that controls power supply from a battery to a load in a vehicle and that cause the one or more processors to perform the following functions. The functions includes: acquiring information of the vehicle; acquiring a charge amount of the battery; identifying a usage state of the vehicle corresponding to the information of the vehicle; and restricting the power supply from the battery to the load based on the usage state of the vehicle, when the charge amount of the battery is less than a first threshold.

According to the power supply control device and the like of the present disclosure, since the power supply from the battery to the load is restricted in accordance with the usage state of the vehicle, the function of the load can be preferably restricted.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a functional block diagram of a power supply control device according to the present embodiment and peripheral components thereof;

FIG. 2 is a diagram showing an example of a use case pattern;

FIG. 3 is a flowchart of a power supply control process executed by the power supply control device;

FIG. 4 is an example of a timing chart of functional restriction of a load controlled by the power supply control process; and

FIG. 5 is a flowchart of another power supply control process executed by the power supply control device.

### DETAILED DESCRIPTION OF EMBODIMENTS

A power supply control device of the present disclosure restricts power supply from a battery to a load such as in-vehicle equipment based on a usage state (use case state) of a vehicle when the charge amount in the battery is lower than a predetermined value. Thus, a function of the load can be suitably restricted.

Hereinafter, an embodiment of the present disclosure will be described in detail with reference to the drawings.

### EMBODIMENT

Configuration

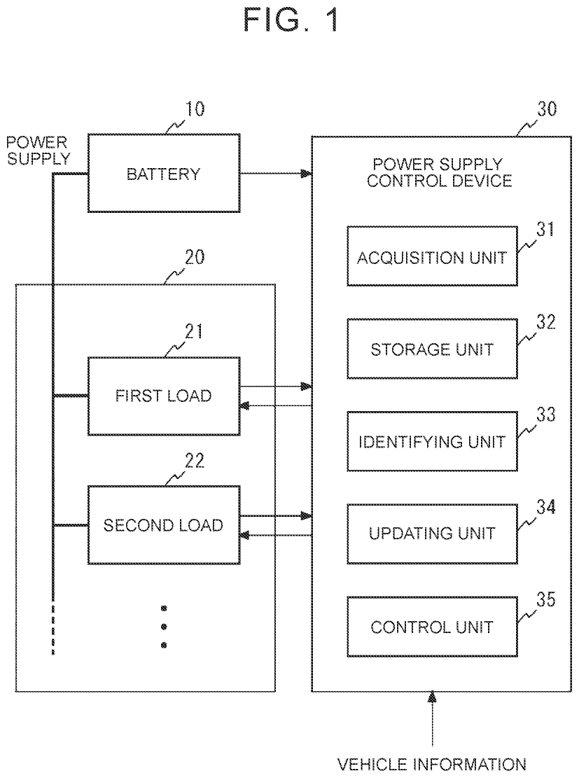

FIG. 1 is a functional block diagram of a power supply control device 30 and peripheral components of the power supply control device 30 according to an embodiment of the present disclosure. The functional block illustrated in FIG. 1 includes a battery 10, a load 20 including a first load 21 and a second load 22, and the power supply control device 30. The load 20 may further include a load other than the first load 21 and the second load 22 shown in FIG. 1. The battery 10, the load 20, and the power supply control device 30 are mounted on a vehicle or the like.

The battery 10 is a chargeable/dischargeable secondary battery such as a lithium-ion battery or a lead-acid battery. The battery 10 is connected to the first load 21, the second load 22, and the like so as to be able to supply power. In addition, the battery 10 is configured to be able to output information (battery information) including the output voltage, the input/output current, and the charge amount (or remaining amount) that is the amount of accumulated power (SOC), to the power supply control device 30. The battery 10 can be exemplified by an auxiliary battery that supplies necessary electric power to auxiliary equipment that is not related to the driving of the vehicle.

The first load 21, the second load 22, and the like are equipment mounted on the vehicle, and are configured to operate with the power of the battery 10. When the battery 10 is an auxiliary battery, the auxiliary equipment such as an air conditioner and a surveillance camera can be exemplified as the first load 21 and the second load 22. The first load 21 and the second load 22 and the like are configured to be able to output information (equipment information) including a usage state such as an operating state (number of relay driving times, driving time) and a consumption current (or power consumption) of the actuators provided in the first load 21 and the second load 22, to the power supply control device 30. In addition, the first load 21 and the second load 22 and the like are configured so as to be able to partially or entirely stop the functions (restriction functions) by restricting the power supply from the battery 10, based on the control by the power supply control device 30.

The power supply control device 30 is a configuration for controlling the power supply from the battery 10 to the load 20 based on the state of the battery 10, the state of the vehicle obtained from the configuration other than the load 20 and the load 20, and the like. The power supply control device 30 includes an acquisition unit 31, a storage unit 32, an identifying unit 33, an updating unit 34 and a control unit 35.

The acquisition unit 31 acquires (or collects) various information about the vehicle. More specifically, the acquisition unit 31 acquires vehicle information (functions as a first acquisition unit) including device information of the first load 21 and the second load 22 and the like, vehicle position information, door lock opening/closing information, driver seating information (the weight of the driver's seat), and the like. The acquisition unit 31 also acquires battery information (functions as a second acquisition unit) including at least the charge amount (remaining amount) of the battery 10 from the battery 10.

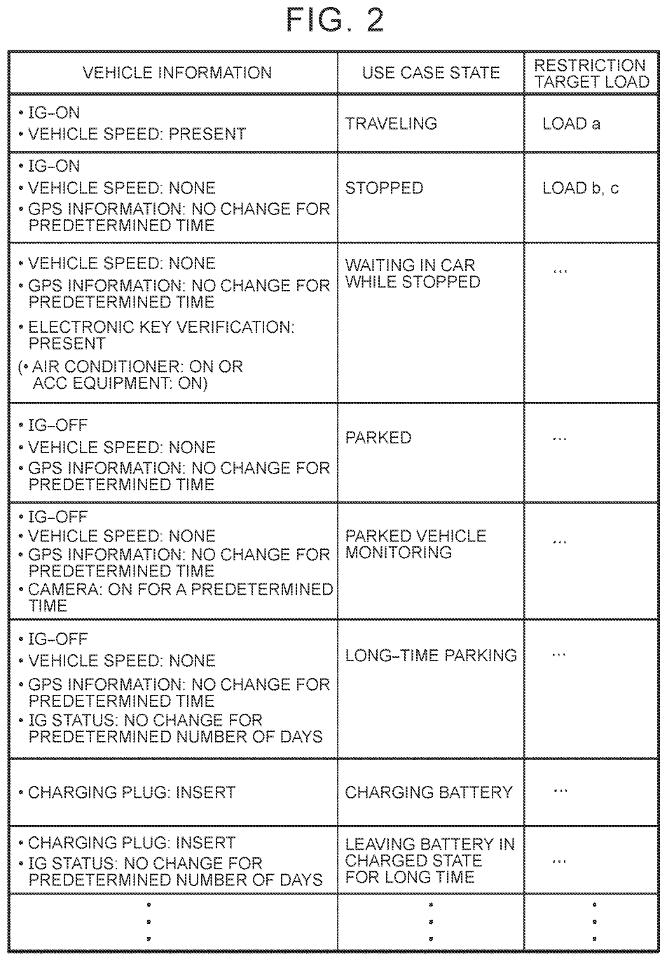

The storage unit 32 stores use case pattern information obtained by associating and combining the use case state that is the usage state of the vehicle, and the vehicle information. FIG. 2 shows an example of the use case pattern information stored in the storage unit 32. In FIG. 2, the use case state associated with one or more vehicle states obtained from the vehicle information are defined, and the load to be restricted in the state (restriction target load) is associated with the use case state beforehand. For example, when it can be determined from the vehicle information that the ignition switch is in the on state (IG-ON) and the vehicle speed exceeds 0 km/h (there is vehicle speed), the use case state of “traveling” is identified, and it is indicated that the power supply to load a is restricted during this “traveling”. The use case state can be defined based on the location, the time, the vehicle state, and the like. In addition, it can be defined based on a power consumption reduction, vehicle cabin comfort, a battery life, a Sunday driver, etc. A Sunday driver is a driver who drives infrequently because they only drive on weekends. For example, when the use case state is “it is comfortable in the vehicle cabin”, the power supply restriction is set so that the operation of the air conditioner is prioritized. In a case in which the use case state is “Sunday driver”, when the vehicle is an electrified vehicle equipped with a V2H function that supplies power to the home from the vehicle, the power of the battery 10 is actively supplied to the home until Saturday, and it is conceivable that the power supply restriction in which the battery 10 is charged to a fully charged state by Sunday morning is set.

The identifying unit 33 identifies the usage state (use case state) of the vehicle corresponding to the vehicle information acquired by the acquisition unit 31 by extracting the usage state of the vehicle from the storage unit 32. For example, when the vehicle information is that the ignition switch is in the off state (IG-OFF), the vehicle speed is 0 km/h (no vehicle speed), and the vehicle has not moved for a predetermined time (GPS information does not change for a predetermined time), the identifying unit 33 identifies the use case state that the vehicle is “parked”.

The identifying unit 33 may not extract the usage state (use case state) of the vehicle stored in the storage unit 32, and may identify a result obtained by inputting vehicle information acquired by the acquisition unit 31 into a pre-created machine learning model as the usage state (use case state) of the vehicle.

The updating unit 34 can update the use case pattern information stored in the storage unit 32 based on the vehicle information currently acquired by the acquisition unit 31. More specifically, the updating unit 34 can appropriately update the vehicle information (vehicle state) associated with the use case state in the use case pattern information. The updating unit 34 may determine whether the vehicle information is updated (whether the condition is relaxed or the condition is strengthened), based on whether a change (predetermined change) preset for each use case state has been detected, etc.

The control unit 35 determines the charge amount of the battery 10 based on the battery information acquired by the acquisition unit 31. Based on the determined charge amount of the battery 10 and the usage state (use case state) of the vehicle identified by the identifying unit 33, the control unit 35 restricts the power supply from the battery 10 to the load (such as the first load 21 and the second load 22). The control executed by the control unit 35 will be described later.

The power supply control device 30 described above typically includes a processor such as a microcomputer, a memory, an input/output interface, and the like. This power supply control device 30 can realize some or all of the functions of the acquisition unit 31, the storage unit 32, the identifying unit 33, the updating unit 34, and the control unit when the processor reads and executes the program stored in the memory.

Control

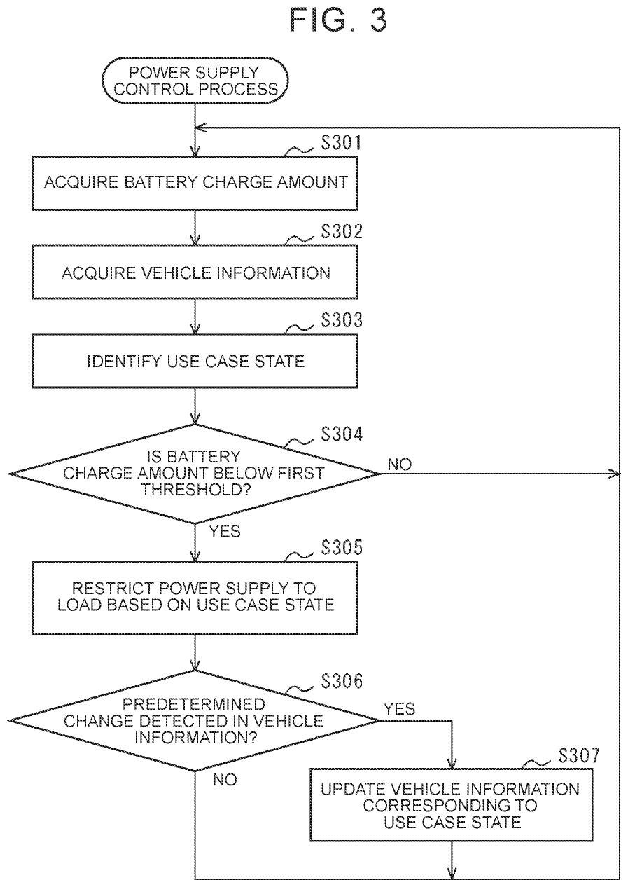

Next, the control executed by the power supply control device 30 according to the present embodiment will be described with further reference to FIGS. 3 to 5. FIG. 3 is a flowchart showing a procedure of power supply control process executed by each component of the power supply control device 30.

Step S301

The acquisition unit 31 acquires the charge amount of the battery 10. The charge amount of the battery 10 may be acquired constantly, or may be acquired at predetermined intervals by using a counter or the like. When the charge amount of the battery is acquired, the process proceeds to step S302.

Step S302

The acquisition unit 31 acquires the vehicle information (such as a vehicle information list). This vehicle information may be acquired constantly, or may be acquired each time the charge amount of the battery 10 is acquired. After the vehicle information is acquired, the process proceeds to step S303.

Step S303

The identifying unit 33 identifies the use case state. This use case state identification is executed by extracting, from the storage unit 32, the usage state of the vehicle corresponding to the vehicle information acquired by the acquisition unit 31. When a use case state cannot be identified so as to be narrowed down to one, the use case state identified in the previous process may be maintained as is, or the current process may be terminated with the use case state undefined. Further, instead of the current vehicle information acquired by the acquisition unit 31, the use case state may be identified by using the operation status behavior based on big data or by using the vehicle information in one trip. Once the use case state is identified, the process proceeds to step S304.

Step S304

The control unit 35 determines whether the charge amount of the battery 10 is less than a first threshold. This first threshold is a predetermined charge amount for determining whether to restrict the power supply to the load (such as the first load 21 and the second load 22), and can be set as desired in accordance with the performance and capacity of the battery 10. When the charge amount of the battery 10 is less than the first threshold (step S304, yes), the process proceeds to step S305, and when the charge amount of the battery 10 is equal to or greater than the first threshold (step S304, no), the process proceeds to step S301.

Step S305

The control unit 35 restricts the power supply from the battery 10 to the load based on the use case state. More specifically, based on a restriction target load associated with the use case state identified by the identifying unit 33 in step S303 and stored in the storage unit 32, the control unit 35 restricts the power supply from the battery 10 to the load (such as the first load 21 and the second load 22). This restriction may be executed, for example, by issuing an instruction regarding the function restriction level from the control unit 35 to the target load, or may be executed by the control unit 35 giving information on the power that can be used (consumed) by the target load. When the power supply from the battery 10 to the load is restricted based on the use case state, the process proceeds to step S306.

Step S306

The updating unit 34 determines whether a predetermined change has been detected in the vehicle information. More specifically, the updating unit 34 determines whether a preset change is detected, between the vehicle information (current vehicle information) acquired by the acquisition unit 31 in step S302 and the vehicle information (past vehicle information) associated with the use case state identified in step S303 and stored in the storage unit 32. The degree of change can be set as desired. When the predetermined change in the vehicle information is detected (step S306, yes), the process proceeds to step S307, and when the predetermined change in the vehicle information is not detected (step S306, no), the process proceeds to step S301.

Step S307

The updating unit 34 updates the vehicle information corresponding to the use case state. More specifically, the updating unit 34 updates the vehicle information stored in the storage unit 32 in association with the use case state by replacing it with the vehicle information acquired by the acquisition unit 31 in step S302. Through this update, the use case pattern information with suitable content is learned in accordance with how the vehicle is used by the vehicle user such as the driver. For the learning of the use case pattern information, the vehicle user may be allowed to set the weighting of vehicle information by himself/herself. When the vehicle information corresponding to the use case state is updated, the process proceeds to step S301.

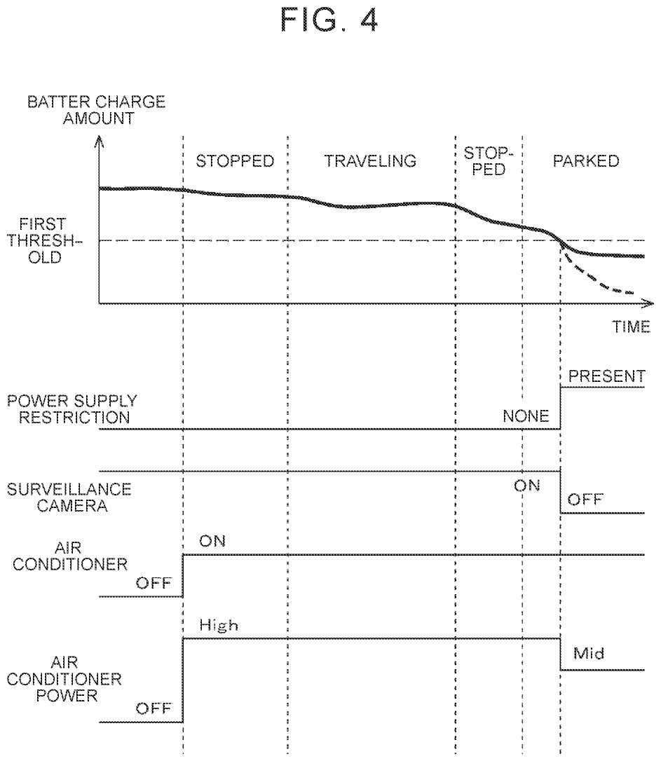

FIG. 4 is a diagram showing an example of the power supply restriction based on the power supply control process described with reference to FIG. 3. In the example of FIG. 4, when the charge amount of the battery 10 of the vehicle becomes less than the first threshold, based on the use case state “parking” identified at that time, the power supply to the “surveillance camera” for monitoring the surroundings and the “air conditioner” for remote air conditioning that are associated with the use case state “parking” as the restriction target load is restricted. Specifically, the operation of the “surveillance camera” is terminated (recording time is shortened), and the air volume of the “air conditioner” is reduced (high to medium). This process of restricting the power supply can suppress a decrease in the charge amount in the battery 10 compared to the case where the restriction is not implemented (dotted line in FIG. 4).

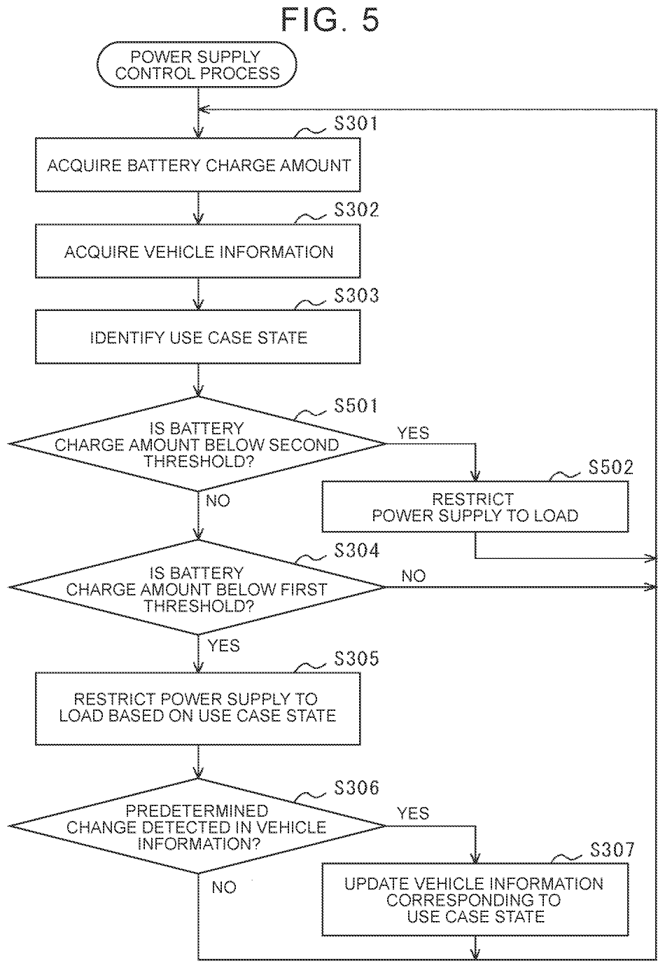

FIG. 5 is a flowchart showing a procedure of another power supply control process executed by each component of the power supply control device 30. The other power supply control process shown in FIG. 5 differs from the power supply control process shown in FIG. 3 in that steps S501 and S502 are added. The other power supply control process shown in FIG. 5 will be described below, focusing on the added steps.

Step S303

The identifying unit 33 identifies the use case state. This use case state identification is performed by extracting, from the storage unit 32, the usage state of the vehicle corresponding to the vehicle information acquired by the acquisition unit 31. Once the use case state is identified, the process proceeds to step S501.

Step S501

The control unit 35 determines whether the charge amount of the battery 10 is less than a second threshold. This second threshold is the charge amount for determining whether a stricter restriction than the power supply restriction to the load performed in step S305 is necessary. Thus, it is desirable that the second threshold is set to a predetermined value lower than the first threshold, and it is further preferable that the second threshold is set to the lower limit of the charge amount for avoiding over discharge. When the charge amount of the battery 10 is less than the second threshold (step S501, yes), the process proceeds to step S502, and when the charge amount of the battery 10 is equal to or greater than the second threshold (step S501, no), the process proceeds to step S304.

Step S502

The control unit 35 restricts the power supply from the battery 10 to the load. More specifically, regardless of the use case state identified by the identifying unit 33 in step S303, the control unit 35 restricts power supply so that power is supplied from the battery 10 to only the minimum load necessary for safety for the vehicle to run, stop, and turn. When the power supply from the battery 10 to the load is restricted, the process proceeds to step S301.

Step S304

The control unit 35 determines whether the charge amount of the battery 10 is less than a first threshold. That is, the control unit 35 determines whether the charge amount of the battery 10 is equal to or greater than the second threshold and less than the first threshold, or equal to or greater than the first threshold. When the charge amount of the battery 10 is equal to or greater than the second threshold and less than the first threshold (step S304, yes), the process proceeds to step S305, and when the charge amount of the battery 10 is equal to or greater than the first threshold (step S304, no), the process proceeds to step S301.

Operations, Effects, Etc.

As described above, according to the power supply control device 30 according to an embodiment of the present disclosure, when the charge amount of the battery is less than the first threshold, power supply to the load (such as the first load 21 and the second load 22) is restricted based on the usage state (use case state) of the vehicle. Thereby, it is possible to suitably restrict the function of the load.

Further, according to the power supply control device 30 according to an embodiment of the present disclosure, the vehicle information corresponding to the use case state is updated as necessary. Through this process, the use case pattern information with suitable content can be learned in accordance with how the vehicle is used by the vehicle user such as the driver.

Although one embodiment of the technique of the present disclosure has been described above, the present disclosure can be interpreted as a method executed by a power supply control device including a processor and a memory, a program of the method, a computer-readable, non-transitory storage medium that stores the program, for example, in addition to the power supply control device.

Further, when the present disclosure is regarded as a vehicle energy control system, the following aspect can be illustrated as an example.

A vehicle energy control system that has a mechanism of restricting the energy usage amount in view of a usage state and an energy remaining amount of an energy source in the vehicle, from a mechanism for monitoring a remaining amount of an auxiliary battery in a vehicle, a mechanism for monitoring vehicle information, and a mechanism for learning and estimating a use case based on the above information.

Alternatively, a vehicle energy control system that has a mechanism of allocating energy to a function following a use case and restricting a function, in view of a usage state and an energy remaining amount of an energy source in a vehicle, from a mechanism for monitoring a remaining amount of an auxiliary battery in the vehicle, a mechanism for monitoring vehicle information, and a mechanism for estimating the use case based on the above information, and that includes supplying power to those functions.

Alternatively, a vehicle energy control system that has a mechanism of allocating energy to a function following a use case and restricting an energy usage amount, in view of a usage state and an energy remaining amount of an energy source in the vehicle, from a mechanism for monitoring a remaining amount of an auxiliary battery in a vehicle, a mechanism for monitoring vehicle information, and a mechanism for estimating a use case based on the above information, and that includes a function of calculating function restriction information in the vehicle in a step-wise manner from the energy usage amount, and that includes supplying power to a necessary function by function restriction information.

Alternatively, a vehicle energy control system including an auxiliary battery information collecting device for recording/collecting a remaining amount of an auxiliary battery in a vehicle, an in-vehicle information collecting device having a mechanism for monitoring vehicle information, a vehicle usage state recording device for recording the information, and a function restriction control device for allocating energy to a function following a use case and restricting the function, in view of the usage state and the energy remaining amount of the energy source in the vehicle, from an estimated use case.

The power supply control device and the like according to the present disclosure can be used when controlling a power supply from a battery to a load in a vehicle.

What is claimed is:

1. A power supply control device configured to control power supply from a battery to a load in a vehicle, the power supply control device comprising one or more processors configured to:
acquire information of the vehicle;
acquire a charge amount of the battery;
identify a usage state of the vehicle corresponding to the acquired information of the vehicle; and
restrict the power supply from the battery to the load based on the identified usage state of the vehicle, when the acquired charge amount of the battery is less than a first threshold.

2. The power supply control device according to claim 1 further comprising a memory configured to store a combination of information of the vehicle and the usage state of the vehicle,
wherein the one or more processors are configured to identify the usage state of the vehicle corresponding to the acquired information of the vehicle based on the stored combination.

3. The power supply control device according to claim 2, wherein
the memory is configured to further store a load that is a restriction target of the power supply for each usage state of the vehicle, and
the one or more processors are configured to restrict the power supply from the battery to the load, based on the stored load that is a restriction target of the power supply, when the acquired charge amount of the battery is less than the first threshold.

4. The power supply control device according to claim 2, wherein the one or more processors are configured to update past information of the vehicle stored in combination with the identified usage state of the vehicle, based on an acquired current information of the vehicle.

5. The power supply control device according to claim 1, wherein the one or more processors are configured to supply power to a minimum load necessary for the vehicle to travel, when the charge amount of the battery is less than a second threshold that is smaller than the first threshold.

6. A method executed by a computer of a power supply control device that controls power supply from a battery to a load in a vehicle, the method comprising:
acquiring information of the vehicle;
acquiring a charge amount of the battery;
identifying a usage state of the vehicle corresponding to the information of the vehicle; and
restricting the power supply from the battery to the load based on the usage state of the vehicle, when the charge amount of the battery is less than a first threshold.

7. A non-transitory storage medium storing instructions that are executable by one or more processors of a power supply control device that controls power supply from a battery to a load in a vehicle and that cause the one or more processors to perform functions comprising:
acquiring information of the vehicle;
acquiring a charge amount of the battery;
identifying a usage state of the vehicle corresponding to the information of the vehicle; and
restricting the power supply from the battery to the load based on the usage state of the vehicle, when the charge amount of the battery is less than a first threshold.
